(19) United States
(12) Patent Application Publication
(10) Pub. No.: US 2026/0247291 A1
(43) Pub. Date: Aug. 20, 2026

(54) SYSTEM INFORMATION ACQUISITION FOR ENERGY SAVING

(71) Applicant: QUALCOMM Incorporated, San Diego, CA (US)

(72) Inventors: Naeem AKL, San Jose, CA (US); Navid ABEDINI, Basking Ridge, NJ (US); Karl Georg HAMPEL, Jersey City, NJ (US); Kapil GULATI, Belle Mead, NJ (US); Junyi LI, Greentown, PA (US)

(21) Appl. No.: 19/054,616

(22) Filed: Feb. 14, 2025

(51) Int. Cl. H04W 52/02; H04W 64/00

(52) U.S. Cl. CPC H04W 52/028; H04W 52/0206; H04W 64/006

(57) ABSTRACT

Methods, systems, and devices for wireless communications are described. A user equipment (UE) may transmit a message including information associated with a predicted movement trajectory of the UE. The information may include a current serving cell or tracking area associated with a current location of the UE, a set of one or more cells or tracking areas corresponding to the predicted movement trajectory of the UE, a destination associated with the predicted movement trajectory, an identity of the UE, or any combination thereof. The UE may receive system information for a predicted set of cells corresponding to the predicted movement trajectory of the UE. The UE may verify the system information received for at least a subset of the predicted set of cells and perform wireless communications via at least the subset of the predicted set of cells based on the verifying.

### TECHNICAL FIELD

The following relates to wireless communications, including system information acquisition for energy saving.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). Components within a wireless communication system may be coupled (for example, operatively, communicatively, functionally, electronically, and/or electrically) to each other.

### SUMMARY

The systems, methods, and devices of this disclosure each have several innovative aspects, no single one of which is solely responsible for the desirable attributes disclosed herein.

A method for wireless communication by a user equipment (UE) is described. The method may include transmitting a message including information associated with a predicted movement trajectory of the UE, receiving system information (SI) for a predicted set of cells corresponding to the predicted movement trajectory of the UE, verifying the SI received for at least a subset of the predicted set of cells, and performing wireless communications via at least the subset of the predicted set of cells based on the verifying.

A UE for wireless communications is described. The UE may include one or more memories storing processor-executable code, and one or more processors coupled with (e.g., operatively, communicatively, functionally, electronically, or electrically) the one or more memories. The one or more processors may be individually or collectively operable to execute the code (e.g., directly, indirectly, after pre-processing, without pre-processing) to cause the UE to transmit a message including information associated with a predicted movement trajectory of the UE, receive SI for a predicted set of cells corresponding to the predicted movement trajectory of the UE, verify the SI received for at least a subset of the predicted set of cells, and perform wireless communications via at least the subset of the predicted set of cells based on the verifying.

A non-transitory computer-readable medium storing code for wireless communications at a UE is described. The code may include instructions executable by at least one processor (e.g., directly, indirectly, after pre-processing, without pre-processing) to transmit a message including information associated with a predicted movement trajectory of the UE, receive SI for a predicted set of cells corresponding to the predicted movement trajectory of the UE, verify the SI received for at least a subset of the predicted set of cells, and perform wireless communications via at least the subset of the predicted set of cells based on the verifying.

In some examples of the method, UE, and non-transitory computer-readable medium described herein, the information associated with the predicted movement trajectory includes a current serving cell associated with a current location of the UE, a current tracking area associated with the current location of the UE, a set of one or more cells corresponding to the predicted movement trajectory, a set of one or more tracking areas corresponding to the predicted movement trajectory, a destination associated with the predicted movement trajectory, an identity of the UE, or any combination thereof.

Some examples of the method, UE, and non-transitory computer-readable medium described herein may further include operations, features, means, or instructions for receiving, via the SI, a set of multiple version identity values, each version identity value of the set of multiple version identity values associated with a respective cell of the predicted set of cells.

Some examples of the method, UE, and non-transitory computer-readable medium described herein may further include operations, features, means, or instructions for detecting a first cell of the predicted set of cells and detecting a current version identity value for the first cell, where the verifying may be based on comparing the current version identity value for the first cell to a first version identity value of the set of multiple version identity values received via the SI.

Some examples of the method, UE, and non-transitory computer-readable medium described herein may further include operations, features, means, or instructions for receiving second SI via the first cell, the second SI including an indication of the current version identity value.

Some examples of the method, UE, and non-transitory computer-readable medium described herein may further include operations, features, means, or instructions for transmitting feedback on an accuracy of the predicted set of cells based on a comparison between a set of detected cells and the predicted set of cells, a validity of the SI, or a combination thereof.

Some examples of the method, UE, and non-transitory computer-readable medium described herein may further include operations, features, means, or instructions for receiving, via the SI, an expiry time associated with the SI for each cell of the predicted set of cells, where the predicted set of cells may be considered valid until expiration of the expiry time.

Some examples of the method, UE, and non-transitory computer-readable medium described herein may further include operations, features, means, or instructions for transmitting, in the message, a request for the SI for a time interval, where the predicted set of cells may be considered valid until expiration of the time interval.

Some examples of the method, UE, and non-transitory computer-readable medium described herein may further include operations, features, means, or instructions for determining that the SI for at least one cell of at least the subset of the predicted set of cells may be expired based on the verifying and receiving updated SI for the at least one cell based on determining that the SI may be expired.

Some examples of the method, UE, and non-transitory computer-readable medium described herein may further include operations, features, means, or instructions for detecting at least one cell that may be not included in the predicted set of cells and receiving SI for the at least one cell.

In some examples of the method, UE, and non-transitory computer-readable medium described herein, the predicted set of cells may be associated with a portion of a predicted or historical trajectory of the UE.

In some examples of the method, UE, and non-transitory computer-readable medium described herein, receiving the SI for the predicted set of cells may include operations, features, means, or instructions for receiving the SI via user plane or control plane signaling.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports system information acquisition for energy saving in accordance with one or more aspects of the present disclosure.

FIG. 2 shows an example of a wireless communications system that supports system information acquisition for energy saving in accordance with one or more aspects of the present disclosure.

FIG. 3 shows an example of a process flow that supports system information acquisition for energy saving in accordance with one or more aspects of the present disclosure.

FIGS. 4 and 5 show block diagrams of devices that support system information acquisition for energy saving in accordance with one or more aspects of the present disclosure.

FIG. 6 shows a block diagram of a communications manager that supports system information acquisition for energy saving in accordance with one or more aspects of the present disclosure.

FIG. 7 shows a diagram of a system including a device that supports system information acquisition for energy saving in accordance with one or more aspects of the present disclosure.

FIG. 8 shows a flowchart illustrating methods that support system information acquisition for energy saving in accordance with one or more aspects of the present disclosure.

FIG. 9 shows a flowchart illustrating methods that support system information acquisition for energy saving in accordance with one or more aspects of the present disclosure.

FIG. 10 shows a flowchart illustrating methods that support system information acquisition for energy saving in accordance with one or more aspects of the present disclosure.

### DETAILED DESCRIPTION

In some wireless communications systems, a user equipment (UE) may obtain system information for a given cell, based on which the UE may proceed to perform wireless communications. For example, the UE may be within coverage of a cell, and may acquire system information (SI) for the cell. As the UE moves, the UE may enter a different cell and acquire SI for the new cell. Network energy savings (NES) techniques may reduce energy consumption associated with the downlink communication of SI between a network entity and a UE. For example, a wireless communications system may configure cells to provide on-demand SI Block1 (SIB1) in anchored deployment for idle or inactive UEs. In another example, a wireless communications system may configure secondary cells (SCells) to provide on-demand system synchronization block (SSB) for connected UEs. However, such techniques do not mitigate the consumption of power and computational resources associated with a UE acquiring new SI each time the UE travels to a new cell. Further, the network expends additional power to provide on-demand SSBs and SI. Thus, techniques for more efficient SI acquisition could provide greater energy savings at both the UE and the network.

Accordingly, the techniques described herein provide for employing machine learning (ML) and artificial intelligence (AI) to reduce energy consumption associated with SI acquisition. A UE may provide an indication of a movement trajectory of the UE (e.g., a current serving cell or tracking area, predicted cells or tracking areas to be observed by the UE as the UE moves, a destination of a UE trip, a UE identity) to an SI service (e.g., at the network, at the UE, or at another UE). In some cases, the UE may use ML or AI to directly provide the SI service with a predicted set of cells to be observed by the UE (e.g., a set of cells corresponding to a predicted trajectory, such as a commonly traveled route). In some implementations, the UE may provide information (e.g., information associated with a predicted movement trajectory) to the network. For example, the UE may provide a UE identity to the network, and the network may use ML or AI to generate a predicted movement trajectory of the UE associated with the UE identity (e.g., based on previously traveled routes by the UE indicated by the UE identify). The SI service may transmit, to the UE, SI of a first SI type (e.g., other SI (OSI), SIB1) for the predicted set of cells along the predicted movement trajectory of the UE. As the UE moves along a trajectory, the UE may verify the SI received for each of the cells the UE enters (e.g., instead of receiving and processing a complete SI for the cell), and may perform wireless communications with each cell based on verification of the SI for that cell. For example, the UE may receive, in SI of a second SI type (e.g., in SSB, SIB1, or master information block (MIB)), a current version identity of the SI of the first SI type for a cell. The UE may compare the current version identity of the SI of the first SI type for the cell to the version identity received from the SI service. If the version identifies match, the UE may not unnecessarily expend resources receiving, decoding, or processing the complete SE for the newly entered cell.

Such techniques may provide energy savings at the UE by allowing the UE to refrain from monitoring for or requesting SI of the first SI type for each cell the UE enters. Such techniques may also provide energy savings at the network compared to on-demand techniques for SI acquisition by reducing energy consumption associated with receiving SI requests from the UE and transmitting on-demand SI of the first SI type each time the UE changes cells.

Aspects of the disclosure are initially described in the context of wireless communications systems. Aspects of the disclosure are further illustrated by and described with reference to wireless communications systems and process flows. Aspects of the disclosure are further illustrated by and described with reference to apparatus diagrams, system diagrams, and flowcharts that relate to SI acquisition for energy saving.

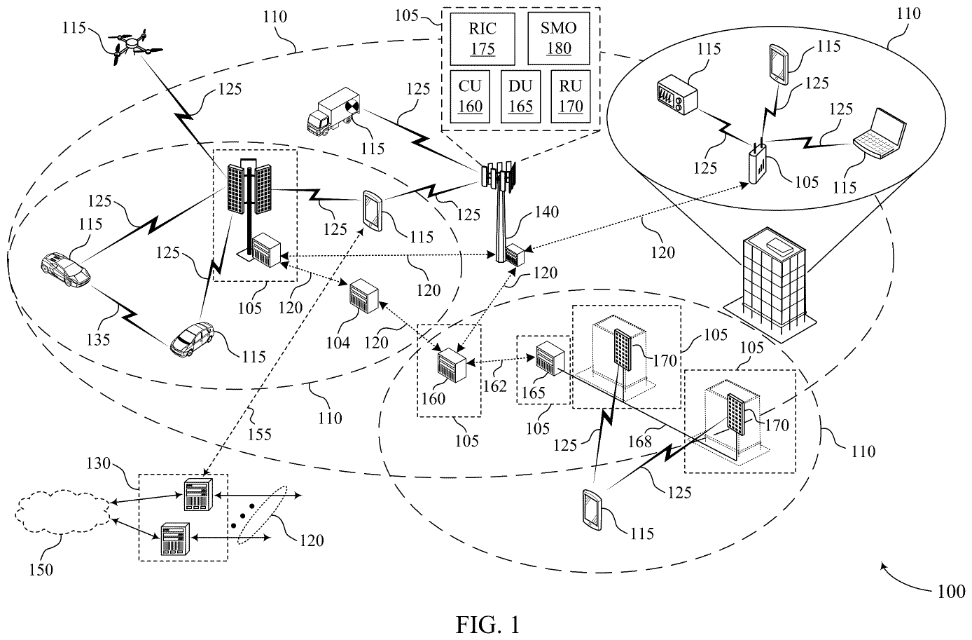

FIG. 1 shows an example of a wireless communications system 100 that supports SI acquisition for energy saving in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may be a device such as a cellular phone, a smart phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may also refer to a wireless local loop (WLL) station, an Internet of Things (IoT) device, an Internet of Everything (IoE) device, or an MTC device, or the like, which may be implemented in various articles such as appliances, drones, robots, vehicles, meters, or the like.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support SI acquisition for energy saving as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, SI), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., Nf) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane (UP), communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane (CP), an RRC layer may provide establishment, configuration, and maintenance of an RRC connection between a UE 115 and a network entity 105 or a core network 130 supporting radio bearers for UP data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support aggregating SI delivery and acquisition for multiple cells for energy saving. In some cases, a UE 115 may provide an indication of a movement trajectory of the UE 115 (e.g., a current serving cell or tracking area, a predicted set of cells or tracking areas to be observed by the UE 115 as the UE 115 moves, a destination of a UE trip, a UE identity, or any combination thereof) to an SI service, which may reside at the network, at the UE 115, or at another UE 115. The UE 115 may use ML or AI to directly provide a predicted set of SI areas (e.g., a set of cells corresponding to a predicted trajectory, such as a commonly traveled route) to the SI service, or the network (e.g., a location service) may use ML or AI and the indication of the movement trajectory of the UE 115 to determine the predicted set of SI areas. The SI service may aggregate SI for the predicted set of SI areas and transmit the aggregate SI to the UE 115, which may store the aggregate SI. The UE 115 may move along a trajectory and perform wireless communications with one or more SI areas, and the UE 115 may verify the stored SI (e.g., received from the SI service) for each SI area observed by the UE 115 (e.g., instead of receiving and processing a complete SI for the SI area). The UE 115 may, in some examples, observe one or more SI areas for which the UE 115 is unable to verify the stored SI or SI areas that are not included in the predicted set of SI areas, and the UE 115 may reacquire SI (e.g., from the SI service or directly from the one or more SI areas) for the one or more SI areas.

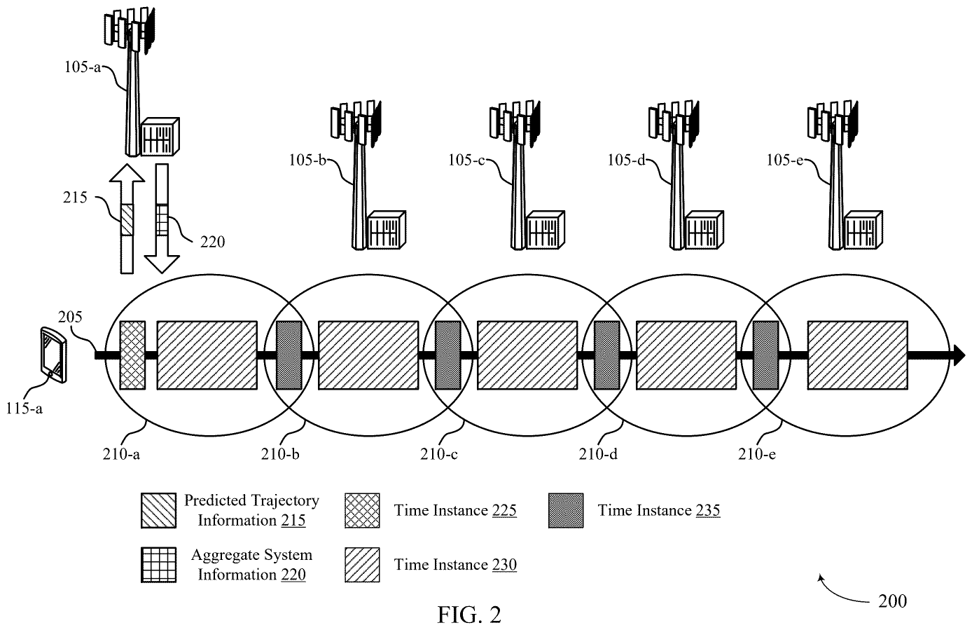

FIG. 2 shows an example of a wireless communications system 200 that supports SI acquisition for energy saving in accordance with one or more aspects of the present disclosure. In some examples, the wireless communications system 200 may implement, or be implemented by, aspects of wireless communications system 100. For example, the wireless communications system 200 may include a network entity 105-a and a UE 115-a, which may be examples of network entities 105, UEs 115, and other wireless devices as described with reference to FIG. 1.

In some examples of the wireless communications system 200, a UE 115-a may move along a movement trajectory 205. As the UE moves along the movement trajectory 205, the UE 115-a may enter one or more SI areas 210 (e.g., serving cells, tracking areas). Each SI area 210 may correspond to a network entity 105. For example, the UE 115-a may initially communicate with a network entity 105-a while in an SI area 210-a, and the UE 115-a may transition into an SI area 210-b and communicate with a network entity 105-b as the UE 115-a moves along the movement trajectory 205. Similarly, the UE 115-a may communicate with one or more additional network entities 105 (e.g., the network entity 105-c, the network entity 105-d, the network entity 105-d, and the network entity 105-e) as the UE 115-a moves along the movement trajectory 205.

In some cases, the UE 115-a may measure SSB and acquire MIB, SIB1, and OSI for each SI area 210 that the UE 115-a enters. For example, the UE 115-a may measure SSB and acquire SI (e.g., MIB, SIB1, OSI) for an SI area 210-c when the UE 115-a transitions from the SI area 210-b into the SI area 210-c. After the UE 115-a has acquired SI for an SI area 210, the UE 115-a may continue to measure SSB while the UE 115-a remains in the SI area 210. While the UE 115-a remains in the SI area 210, the UE 115-a may monitor for changes in SI and optionally process MIB.

In such cases, both the network and the UE 115-a may expend significant energy on SI delivery and acquisition, respectively. For example, the UE 115-a may wake up each time the UE 115-a enters a new SI area 210 in order to acquire SI for the new SI area 210. That is, the UE 115-a may transition out of an idle or inactive state, thereby consuming energy, in order to acquire SI for a currently-observed SI area 210 at each cell selection or SI area change. In some examples, the network entities 105 may continuously broadcast SI, which involves significant consumption of network energy. In some cases, to save network energy, the wireless communications system 200 may support on-demand SI delivery and acquisition. However, on-demand SI delivery may also consume significant network energy due to the large quantity of idle or inactive UEs that send SI demands to the network. On-demand SI delivery may also consume energy at the UE through waking up and sending SI demands, monitoring for SI demand positive acknowledgements (ACKs), monitoring for SI-scheduling physical downlink control channel (PDCCH), and acquiring SI.

Accordingly, the wireless communications system 200 may support aggregating SI delivery and acquisition for multiple SI areas 210 for further energy savings at both the UE 115-a and the network. That is, the network may deliver aggregate SI for multiple SI areas 210 to the UE 115-a to decrease the energy burden associated with SI acquisition to a one-time effort for both the UE 115-a and the network. Such aggregate SI delivery and acquisition may employ ML or AI to make SI acquisition specific to each UE. The UE 115-a may download SI for a predicted set of SI areas 210 determined using ML or AI (e.g., at the UE, at the network, or both). That is, the UE 115-a may selectively download SIs relevant to the UE 115-a (e.g., SIs for a predicted set of SI areas 210 along a predicted movement trajectory of the UE 115-a), thereby saving energy compared to a blind download of SI for SI areas 210 in a neighborhood of the UE (e.g., 2D-vicinity).

In some examples, the UE 115-a may send information associated with a predicted movement trajectory of the UE 115-a (e.g., predicted trajectory information 215) to an SI service and receive in return aggregate SI 220 for a predicted set of SI areas 210 (e.g., cells, tracking areas) corresponding to the predicted movement trajectory (e.g., or neighborhood) of the UE 115-a. That is, the SI service may aggregate SI for the predicted set of SI areas 210 and deliver the aggregate SI 220 to the UE 115-a at a time instance 225. The SI service may reside on the UE 115-a, another UE (e.g., UE cooperation), or the network. For example, the SI service may be an entity deployed in the core network which communicates with the UE over the top (e.g., via NAS or via UP signaling). In some aspects, the UE 115-a may send the predicted trajectory information 215 to a serving enhanced distributed unit (eDU) or another service, and the eDU or other service may forward the predicted trajectory information 215 to the SI service.

In some implementations, the predicted trajectory information 215 may be the predicted set of SI areas 210 corresponding to the predicted movement trajectory of the UE 115-a. For example, an ML or AI model for predicting a set of SI areas 210 to be observed by the UE 115-a may reside at the UE 115-a, and the UE 115-a may directly request SI for the predicted set of SI areas 210 from the SI service. In some examples, the ML or AI model may generate a predicted movement trajectory, and may determine which SI areas 210 are associated with the predicted movement trajectory. For instance, at a given time of day a user may regularly follow a particular trajectory (e.g., to work at a particular time in the morning, back home at a particular time in the evening, or to a particular store or neighborhood at a particular time of day on certain days of the week). The AI or ML model may generate the predicted movement trajectory and corresponding SI areas 210 (e.g., corresponding cells or corresponding tracking areas), which may be indicated in the predicted trajectory information 215, or may be determined based on information in the predicted trajectory information 215 (e.g., the list of predicted or candidate SI areas 210 may be generated based on a current cell identifier for the UE 115-a and one or more additional conditions, such as time of day, current trajectory, mobile or static status, or the like).

Additionally, or alternatively, the predicted trajectory information 215 may be a current serving cell associated with a current location of the UE 115-a, a current tracking area associated with a current location of the UE 115-a, a destination associated with the predicted movement trajectory, an identity of the UE 115-a, or any combination thereof. The SI service may forward the predicted trajectory information 215 to a location service, which may use ML or AI to predict a predicted movement trajectory corresponding to a set of SI areas 210 to be observed by the UE 115-a. The location service may send the predicted set of SI areas 210 to the SI service, and the SI service may deliver the aggregate SI 220 for the predicted set of SI areas 210 to the UE 115-a.

At the time instance 225, the UE 115-a may receive the aggregate SI 220 for the predicted set of SI areas 210 from the SI service. For example, the UE 115-a may receive aggregate OSI for all of the SI areas 210 along the predicted movement trajectory of the UE 115-a. The UE 115-a may additionally receive aggregate SIB1 for all of the SI areas 210 along the predicted movement trajectory of the UE 115-a. In some examples, the aggregate SI 220 may include a version identity, an expiry time, or both for each SI area 210 of the predicted set of SI areas 210. The UE 115-a may, in some cases, request SI for one or more SI areas 210 for a time interval and receive, at the time instance 225, aggregate SI 220 corresponding to the time interval based on the request. For example, the UE 115-a may expect to traverse the predicted movement trajectory within the time interval, and may accordingly request aggregate SI 220 that is valid for the time interval. In some examples, the indicated SI for the predicted movement trajectory may be considered valid until expiry of the indicated expiry time (e.g., at which point the UE 115-a may receive, or may request, updated SI for one or more current or predicted cells).

In some implementations, the aggregate SI 220 may be OSI for all (e.g., or at least a portion of) SI areas 210 along the predicted movement trajectory of the UE 115-a. The UE 115-a may measure SSB, acquire MIB, and acquire SIB1 for the SI area 210-a at the time instance 225. The UE 115-a may also acquire and store OSI for each SI area 210 in the predicted set of SI areas 210 at time instance 225. For example, the predicted movement trajectory may be the movement trajectory 205, and the UE 115-a may acquire OSI for the SI area 210-a, the SI area 210-b, the SI area 210-c, the SI area 210-d, and the SI area 210-e at the time instance 225. After the time instance 225, the UE 115-a may measure SSB, monitor for changes in SI, and optionally process MIB within a time instance 230 while the UE 115-a remains in coverage of the SI area 210-a.

In such implementations, the UE 115-a may verify the stored OSI for each SI area 210 at time instances 235, in which the UE 115-a first transitions into (e.g., observes) an SI area 210. The UE 115-a may be able to measure SSB, acquire MIB, and acquire SIB1 for an SI area 210 at each time instance 235. The UE 115-a may use the acquired SIB1 to verify that the stored OSI for the SI area 210 is accurate and unexpired. For example, the acquired SIB1 may contain a current version identity of the OSI for the SI area 210, and the UE 115-a may compare the current version identity to a version identity of the stored OSI. Additionally, or alternatively, the stored OSI for the SI area 210 may be associated with an expiry time, and the UE 115-a may verify the stored OSI based on comparing a time of observation of the SI area 210 (e.g., the time instance 235) to the expiry time. After verifying the stored OSI, the UE 115-a may measure SSB, monitor for changes in SI, and optionally process MIB within a time instance 230 while the UE 115-a remains in coverage of a given SI area 210.

The exchange of aggregate OSI for all SI areas 210 along the movement trajectory 205 at time instance 225 may save energy at both the UE 115-a and the network. The UE 115-a may refrain from waking up, sending an OSI request, receiving ACKs, and monitoring for and acquiring OSI at each time instance 235 or respective time instances 230, thereby reducing energy consumption. The network may refrain from broadcasting OSI (e.g., or on-demand SI) outside of the time instance 225, thereby saving energy at the network.

In some cases, the aggregate SI 220 may be both SIB1 and OSI for all (e.g., or at least a portion of) SI areas 210 along the predicted movement trajectory of the UE 115-a. The UE 115-a may measure SSB, acquire enhanced MIB, and acquire and store aggregate SIB1 and OSI for each SI area 210 in the predicted set of SI areas 210 at the time instance 225. The enhanced MIB may include a version identity associated with SIB1. For example, the predicted movement trajectory may be the movement trajectory 205, and the UE 115-a may acquire SIB1 and OSI for the SI area 210-a, the SI area 210-b, the SI area 210-c, the SI area 210-d, and the SI area 210-e at the time instance 225. After the time instance 225, the UE 115-a may measure SSB, monitor for changes in SI, and optionally process MIB within a time instance 230 while the UE 115-a remains within coverage of the SI area 210-a.

In such cases, the UE 115-a may verify the stored SIB1, and subsequently verify the stored OSI, for each SI area 210 at time instances 235, in which the UE 115-a first transitions into an SI area 210. The UE 115-a may be able to measure SSB and acquire MIB for an SI area 210 at each time instance 235. The acquired MIB may be enhanced MIB containing a current version identity of the SIB1 for the SI area 210. The UE 115-a may verify (e.g., using the enhanced MIB) that the stored SIB1, and subsequently the stored OSI, for the SI area 210 is accurate and unexpired. For example, the UE 115-a may compare the current version identity (e.g., received in the enhanced MIB or PDCCH) to the version identity of the stored SIB1. Additionally, or alternatively, SIB2-4 of another SI area 210 may indicate the current version identity. That is, an anchor cell may advertise the current SI version identity of nearby cells, and the UE 115-a may acquire the current version identity of an observed cell from the anchor cell. The UE 115-b may verify the validity of SI for multiple cells based on verifying the validity of the stored SIB2-4 associated with the anchor cell. In some aspects, cells neighboring the anchor cell may be NES cells, and implementation of the anchor cell may allow the NES cells to refrain from broadcasting SI and the UE 115-a to refrain from waking up the NES cells, thereby saving energy at both the network and the UE 115-a. In some examples, the stored SIB1 for the SI area 210 may be associated with an expiry time, and the UE 115-a may verify the stored SIB1 based on comparing a time of observation of the SI area 210 (e.g., the time instance 235) to the expiry time. After verifying the stored SIB1 and OSI, the UE 115-a may measure SSB, monitor for changes in SI, and optionally process MIB within a time instance 230 while the UE 115-a remains within coverage of the SI area 210.

The exchange of aggregate SIB1 and OSI for all SI areas 210 along the movement trajectory 205 at the time instance 225 may save energy at both the UE 115-a and the network. The UE 115-a may consume energy to process SSB and MIB, thus refraining from expending additional energy on SI acquisition since the UE 115-a would process SSB and MIB to perform radio measurements independent of SI acquisition. The network may refrain from broadcasting OSI outside of the time instance 225, thereby saving energy. Further, the network may save energy compared to on-demand SIB1 by refraining from broadcasting SIB1 outside of the time instance 225.

In some implementations, the UE 115-a may exchange, with the SI service, feedback on an accuracy of the predicted set of SI areas 210, a validity of SI received from the SI service, or both. In some cases, the SI service may exchange feedback on the accuracy of the predicted set of SI areas 210 with the location service, other UEs 115, other network entities 105, or any combination thereof. For example, the feedback on the accuracy of the predicted set of SI areas 210 may indicate whether the UE 115-a observed the predicted set of SI areas 210 as the UE 115-a moved along the movement trajectory 205 (e.g., if the UE 115-a observed SI areas 210 that were not included in the predicted set of SI areas 210, if the predicted set of SI areas 210 included SI areas 210 that were not observed by the UE 115-a). The feedback on the validity of SI received from the SI service may indicate whether the aggregate SI 220 received from the SI service was valid at a time the UE 115-a observed the predicted set of SI areas 210 (e.g., based on the expiry time, the version identity, or both). That is, the feedback may be based on verifying the stored OSI or SIB1 at the time instances 235. In some examples, the UE 115-a may provide the feedback based on receiving a request (e.g., from the SI service or the network).

In some aspects, the UE 115-a may acquire aggregate SI 220 for a full path or movement trajectory (e.g., a UE trip) at the time instance 225. Additionally, or alternatively, the UE 115-a may be unable to receive SI for sufficiently many SI areas 210 to encompass the entirety of the movement trajectory 205 (e.g., due to memory constraints). That is, the UE 115-a may be unable to store SI for all SI areas 210 associated with a UE trip. Accordingly, the movement trajectory 205 may be partitioned into segments, and the UE 115-a may receive and store aggregate SI 220 at multiple time instances 225 corresponding to each segment of the movement trajectory 205. For example, the UE 115-a may update the stored SI at the beginning of each segment, and the updates to the stored SI may factor in the UE's updated location, the feedback, or both. In some examples, the network may adjust a predicted set of SI areas 210 (e.g., a size of prediction information) based on historical information associated with the UE 115-a (e.g., trip history, historical movement trajectories), an accuracy associated with one or more previous predicted sets of SI areas 210, a type of movement trajectory (e.g., a highway with limited opportunities for exit), or any combination thereof.

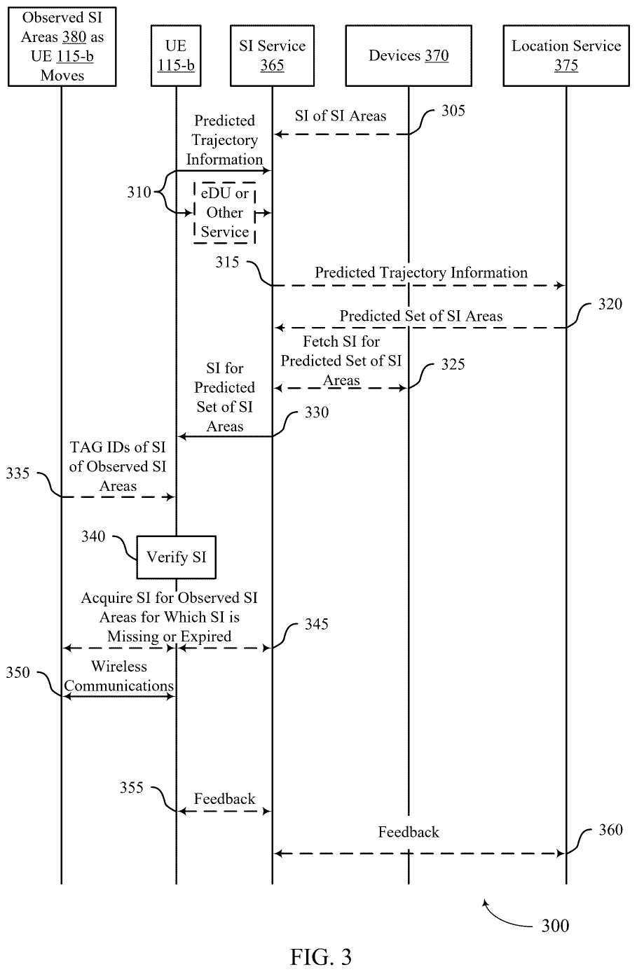

FIG. 3 shows an example of a process flow 300 that supports SI acquisition for energy saving in accordance with one or more aspects of the present disclosure. The process flow 300 may implement or be implemented to realize aspects of the wireless communications systems 100 or 200. For example, the process flow 300 illustrates exchange of aggregate SI information for a predicted set of cells, as described with reference to FIG. 2. The process flow 300 may include a UE 115-b, an SI service 365, devices 370, and a location service 375, which may be examples of corresponding devices described herein. For example, the UE 115-b may be an example of the UE 115-a, as illustrated in FIG. 2. Similarly, the devices 370 may be examples of network entities 105 and UEs 115, as described with reference to FIGS. 1 and 2.

In the following description of the process flow 300, the operations between the observed SI areas 380, the UE 115-b, the SI service 365, the devices 370, and the location service 375 may occur in a different order than the example order shown and, in some examples, may be performed by one or more different devices other than those shown as examples. Some operations also may be omitted from the process flow 300, and other operations may be added to the process flow 300. Further, although some operations or signaling may be shown to occur at different times for discussion purposes, these operations may actually occur at the same time.

At 305, the devices 370 may send SI for one or more SI areas (e.g., cells, tracking areas) to the SI service 365. That is, the SI service 365 aggregates SI for a quantity of SI areas based on receiving the SI from the devices 370. For example, the devices 370 may be network entities, and each network entity may provide coverage to a corresponding cell and accordingly send SI for the corresponding cell to the SI service 365. The SI for each SI area may be associated with an expiry time, a version identity value, or both. In some cases, the SI service 365 may request the SI for the one or more SI areas from the devices 370.

At 310, the SI service 365 may receive a message including information associated with a predicted movement trajectory of the UE 115-b (e.g., predicted trajectory information). The UE 115-b may, in some implementations, directly send the predicted trajectory information to the SI service 365. Additionally, or alternatively, the UE 115-b may send the predicted trajectory information to another entity (e.g., a serving eDU or other service). The serving eDU or the other service may forward the predicted trajectory information to the SI service 365, or the serving eDU or the other service may use the predicted trajectory information to determine a predicted set of SI areas to be observed by the UE 115-b (e.g., using ML or AI) and send the predicted set of SI areas to the SI service 365. In some examples, the SI service 365 may reside on the UE 115-b. In some aspects, the SI service 365 may send a query to request the predicted trajectory information.

In some implementations, the predicted trajectory information may be a predicted set of SI areas corresponding to the predicted movement trajectory of the UE 115-b. That is, an ML or AI model for predicting a predicted movement trajectory corresponding to a set of SI areas to be observed by the UE 115-b may reside at the UE 115-b, and the UE 115-b may directly request SI for the predicted set of SI areas from the SI service 365. Additionally, or alternatively, the predicted trajectory information may be a current serving cell associated with a current location of the UE 115-b, a current tracking area associated with a current location of the UE 115-b, a destination associated with the predicted movement trajectory, an identity of the UE 115-b, or any combination thereof.

In some examples, the UE 115-b may send, in the message at 310, a request for SI for a time interval. That is, the UE 115-b may expect to traverse the predicted movement trajectory within the time interval and accordingly request SI that is valid for one or more SI areas corresponding to the predicted movement trajectory within the time interval. In such examples, the SI for each SI area may correspond to an expiry time, which may indicate that the SI is valid for the time interval.

At 315, the SI service 365 may forward the predicted trajectory information to a location service 375. The location service 375 may use ML or AI to predict a predicted movement trajectory and a corresponding set of SI areas to be observed by the UE 115-b based on the predicted trajectory information. For example, the predicted trajectory information may be an identity of the UE 115-b, and the location service 375 may use ML or AI to predict a set of SI areas based on historical information or past movement trajectories associated with the UE 115-b.

At 320, the location service 375 may send the predicted set of SI areas to the SI service 365. That is, the location service 375 may determine (e.g., using ML or AI) a predicted set of cells to be observed by the UE 115-b based on the predicted trajectory information and transmit the predicted set of cells to the SI service 365.

At 325, the SI service 365 may communicate with the devices 370 to fetch SI for the predicted set of SI areas. In some cases, the SI service 365 may send one or more requests for the SI for the predicted set of SI areas to the devices 370. The devices 370 may send the SI for the predicted set of SI areas in response to receiving the one or more requests. For example, the predicted set of SI areas may correspond to a set of network entities, and the SI service 365 may request and receive the SI for the predicted set of SI areas from the set of network entities. The SI for each SI area may be associated with an expiry time, a version identity value, or both.

At 330, the UE 115-b may obtain (e.g., receive) the SI for the predicted set of SI areas. For instance, the SI service 365 may send the SI for the predicted set of SI areas to the UE 115-b. In some implementations, the UE 115-b may receive, from the SI service 365, the SI for the predicted set of SI areas via UP or CP signaling. In some cases, the SI for each SI area of the predicted set of SI areas may be associated with a version identity value, an expiry time, or both. For example, the UE 115-a may receive, via the SI, a plurality of version identity values, and each version identity value of the plurality of version identity values may be associated with a respective SI area of the predicted set of SI areas. In some aspects, the SI for each SI area may be considered valid until a corresponding expiry time, and the predicted set of SI areas may be considered valid until expiration of the expiry time. The UE 115-b may store the SI for the predicted set of SI areas based on receiving the SI for the predicted set of SI areas at 330.

At 335, the UE 115-b may obtain (e.g., from one or more observed SI areas 380 as the UE 115-b moves) SI. For example, one or more network entities corresponding to one or more cells (e.g., SI areas) may transmit the SI to the UE 115-b. The SI may include a Timing Advance Group (TAG) identifier (ID) of the SI for an observed SI area 380. That is, the UE 115-b may switch SI areas as the UE 115-b moves along a movement trajectory (e.g., the predicted movement trajectory), and the UE 115-b may receive a TAG ID upon first observing each SI area. For example, the TAG ID may identify and allow the UE 115-b to synchronize with each observed SI area 380. In some cases, the UE 115-b may obtain SI including an indication of a current version identity value of the SI for each of the observed SI areas 380 at 335. The indication of the current version identity value may be indicated in SSB, MIB, or SIB1.

At 340, the UE 115-b may verify the stored SI for the predicted set of SI areas that the UE 115-b obtained at 330. For example, the UE 115-b may detect an SI area of the predicted set of SI areas, and the UE 115-b may verify the stored SI based on comparing a version identity value of the stored SI for the SI area to a current version identity value (e.g., indicated at 335) of the SI for the SI area. The UE 115-b may determine that the stored SI for the SI area is valid (e.g., verify) if the version identity value of the stored SI is the same as the current version identity value for the SI area. In some cases, the UE 115-b may identify an observed SI area 380 of the observed SI areas 380 based on a corresponding TAG ID received at 335, and the UE 115-b may accordingly determine if the UE 115-b has unexpired stored SI for the observed SI area 380. For example, the UE 115-b may determine that the UE 115-b does not have stored SI for an observed SI area 380 (e.g., the UE 115-b observes an SI area that is not included in the predicted set of SI areas), or the UE 115-b may determine that the UE 115-b has expired SI for the observed SI area 380 (e.g., the UE 115-b observed the SI area after an expiry time associated with stored SI for the SI area). If the received SI is not valid, or is not included in the aggregated SI previously received at 330, then the UE 115-b may proceed to receive, decode, and process the SI for the current SI area (e.g., cell or tracking area).

At 345, the UE 115-b may acquire SI for observed SI areas 380 for which the UE 115-b does not have stored SI or for which the stored SI is expired. That is, the UE 115-b may obtain SI for observed SI areas 380 for which the UE 115-b unsuccessfully verified SI at 340. The UE 115-b may acquire the SI from the observed SI areas 380, or the UE 115-b may acquire the SI from the SI service 365. For example, the UE 115-b may observe (e.g., detect) at least one SI area of the predicted set of SI areas and determine that the SI for the at least one SI area is expired based on verifying the SI (e.g., at 340), and the UE 115-b may accordingly receive (e.g., from the SI service 365, from the at least one SI area, or a combination thereof) updated SI for the at least one SI area based on determining that the SI is expired. In some cases, the UE 115-b may determine that the stored SI for an observed SI area 380 is expired, and the UE 115-b may transmit the version identity value of the stored SI and reacquire SI for the observed SI area 380 via delta signaling. In some examples, the UE 115-b may detect at least one SI area that is not included in the predicted set of SI areas and accordingly receive SI for the at least one SI area (e.g., from the at least one SI area or from the SI service 365). In some implementations, the UE 115-b may determine that, for one or more observed SI areas 380, the version identity value of the stored SI does not match a current version identity value of the SI, the stored SI for is expired, the UE 115-b does not have stored SI, or any combination thereof (e.g., based on verification at 340), and the UE 115-b may proceed to receive, decode, and process the SI for the one or more observed SI areas 380.

At 350, the UE 115-b may perform wireless communications with the observed SI areas 380 (e.g., which may be at least a subset of the predicted set of SI areas) based on verifying (e.g., at 340) the SI received for the observed SI areas 380. That is, the UE 115-b may move along a movement trajectory (e.g., which may be the predicted movement trajectory), observe SI areas along the movement trajectory, and perform wireless communications with the observed SI areas 380 based on verifying the stored SI at 340, acquiring SI for the observed SI areas 380 at 345, or both.

At 355, the UE 115-b may exchange, with the SI service 365, feedback on an accuracy of the predicted set of SI areas (e.g., based on a comparison between the observed SI areas 380 and the predicted set of SI areas), a validity of SI received from the SI service 365 (e.g., at 330), or both. The feedback may include an indication that the UE 115-b observed (e.g., detected) one or more SI areas that were included in the predicted set of SI areas, an indication that the UE 115-b observed one or more SI areas that were not included in the predicted set of SI areas, an indication of one or more times associated with an observation of one or more SI areas, or any combination thereof. For example, the UE 115-b may provide feedback on the accuracy of the predicted set of SI areas based on whether the UE 115-b observed the SI areas of the predicted set of SI areas as the UE 115-b moved along the movement trajectory. That is, the UE 115-b may compare the predicted set of SI areas to the observed SI areas 380 (e.g., if the UE 115-b observed SI areas 380 that were not included in the predicted set of SI areas, if the UE 115-b stored SI for SI areas that were not observed). In some implementations, the UE 115-b may provide feedback on the validity of SI received from the SI service 365 based on verifying the stored SI at 340. That is, the UE 115-b may provide feedback based on whether the stored SI for the observed SI areas 380 was unexpired (e.g., based on an expiry time) at the time of observation, or based on whether the version identity values of the stored SI were the same as current version identity values (e.g., received at 335) of the observed SI areas 380. In some cases, the UE 115-b may provide the feedback based on receiving a request (e.g., from the SI service 365 or the network).

At 360, the SI service 365 may exchange feedback on an accuracy of the predicted set of SI areas with the location service 375, the devices 370, other services, or any combination thereof. That is, the SI service 365 may send information indicating whether the UE 115-b observed SI areas 380 that were not included in the predicted set of SI areas, if the UE 115-b stored SI for SI areas that were not included in the observed SI areas 380, or both.

In some implementations, the UE 115-b may partition a full movement trajectory (e.g., a predicted movement trajectory or a historical movement trajectory of the UE 115-b) into segments and repeat the process flow 300 for each segment. In such implementations, the predicted set of SI areas may be associated with a portion of a predicted or historical trajectory of the UE 115-b. For example, the UE 115-b may be unable to receive or store SI for sufficiently many SI areas to encompass the full movement trajectory (e.g., due to memory constraints). The UE 115-b may accordingly receive aggregate SI (e.g., at 330) for a first predicted set of cells corresponding to a first segment of the full movement trajectory, and the UE 115-b may propagate feedback on the accuracy of the predicted set of SI areas corresponding to the first segment as the UE 115-b moves along the first segment. The UE 115-b may update stored SI before beginning to traverse a second segment of the full movement trajectory or any subsequent segments. That is, the UE 115-b may acquire and store new aggregate SI corresponding to a new predicted set of SI areas for each segment of the full movement trajectory. The updates of the stored SI may consider an updated location of the UE 115-b (e.g., a destination of a previous segment), an accuracy of the predicted set of SI areas for one or more previous segments (e.g., through feedback at 355, 360, or both), or a combination thereof. For example, the network may adjust a predicted set of SI areas (e.g., a size of prediction information) based on historical information associated with the UE 115-b (e.g., trip history), an accuracy associated with previous predicted set of SI areas, a type of movement trajectory (e.g., a highway with limited opportunities to exit), or any combination thereof.

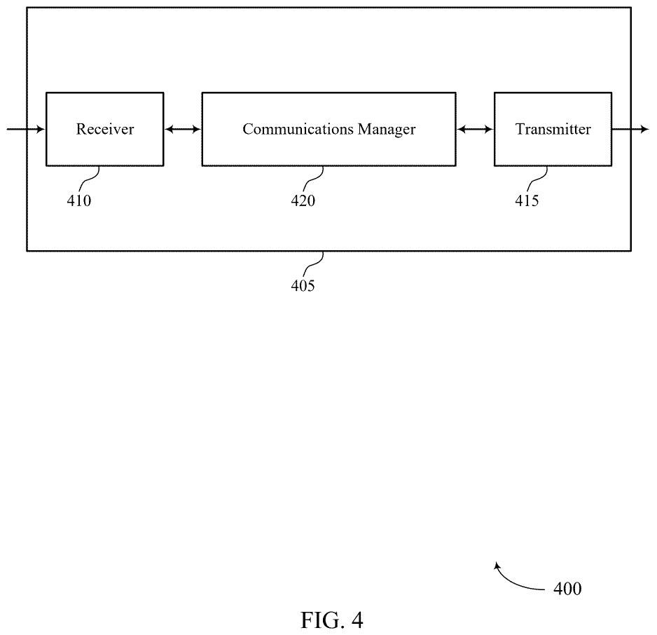

FIG. 4 shows a block diagram 400 of a device 405 that supports SI acquisition for energy saving in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to SI acquisition for energy saving). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to SI acquisition for energy saving). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of SI acquisition for energy saving as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, a graphics processing unit (GPU), a neural processing unit (NPU), an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication in accordance with examples as disclosed herein. For example, the communications manager 420 is capable of, configured to, or operable to support a means for transmitting a message including information associated with a predicted movement trajectory of the UE. The communications manager 420 is capable of, configured to, or operable to support a means for receiving SI for a predicted set of cells corresponding to the predicted movement trajectory of the UE. The communications manager 420 is capable of, configured to, or operable to support a means for verifying the SI received for at least a subset of the predicted set of cells. The communications manager 420 is capable of, configured to, or operable to support a means for performing wireless communications via at least the subset of the predicted set of cells based on the verifying.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced processing and reduced power consumption associated with SI acquisition.

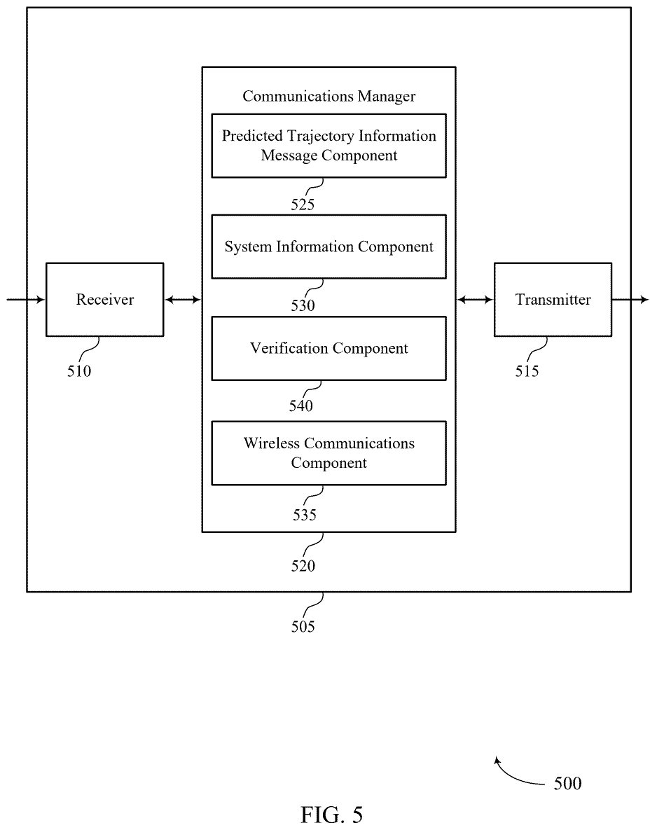

FIG. 5 shows a block diagram 500 of a device 505 that supports SI acquisition for energy saving in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to SI acquisition for energy saving). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to SI acquisition for energy saving). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of SI acquisition for energy saving as described herein. For example, the communications manager 520 may include a predicted trajectory information message component 525, an SI component 530, a wireless communications component 535, a verification component 540, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. The predicted trajectory information message component 525 is capable of, configured to, or operable to support a means for transmitting a message including information associated with a predicted movement trajectory of the UE. The SI component 530 is capable of, configured to, or operable to support a means for receiving SI for a predicted set of cells corresponding to the predicted movement trajectory of the UE. The verification component 540 is capable of, configured to, or operable to support a means for verifying the SI received for at least a subset of the predicted set of cells. The wireless communications component 535 is capable of, configured to, or operable to support a means for performing wireless communications via at least the subset of the predicted set of cells based on the verifying.

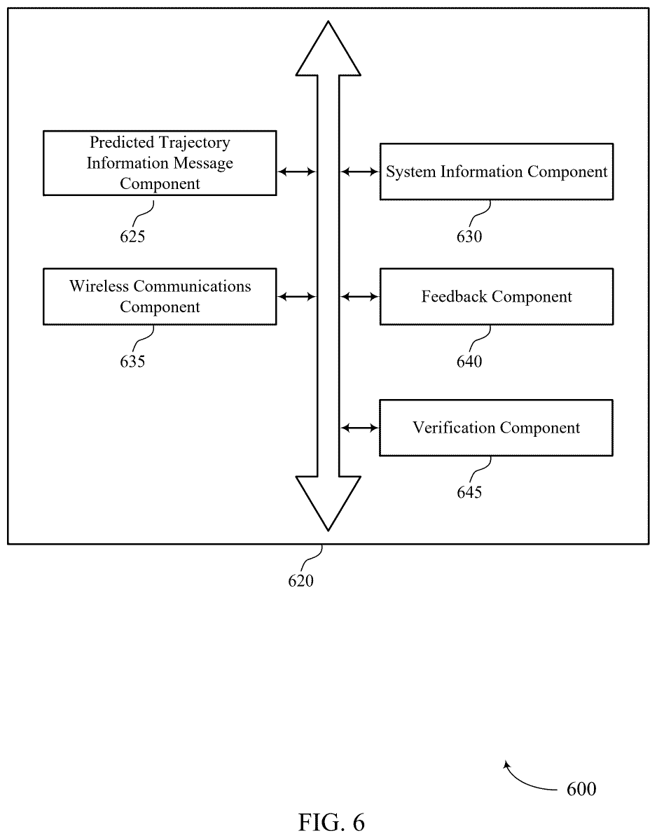

FIG. 6 shows a block diagram 600 of a communications manager 620 that supports SI acquisition for energy saving in accordance with one or more aspects of the present disclosure. The communications manager 620 may be an example of aspects of a communications manager 420, a communications manager 520, or both, as described herein. The communications manager 620, or various components thereof, may be an example of means for performing various aspects of SI acquisition for energy saving as described herein. For example, the communications manager 620 may include a predicted trajectory information message component 625, an SI component 630, a wireless communications component 635, a feedback component 640, a verification component 645, or any combination thereof. Each of these components, or components or subcomponents thereof (e.g., one or more processors, one or more memories), may communicate, directly or indirectly, with one another (e.g., via one or more buses).

The communications manager 620 may support wireless communication in accordance with examples as disclosed herein. The predicted trajectory information message component 625 is capable of, configured to, or operable to support a means for transmitting a message including information associated with a predicted movement trajectory of the UE. The SI component 630 is capable of, configured to, or operable to support a means for receiving SI for a predicted set of cells corresponding to the predicted movement trajectory of the UE. The verification component 645 is capable of, configured to, or operable to support a means for verifying the SI received for at least a subset of the predicted set of cells. The wireless communications component 635 is capable of, configured to, or operable to support a means for performing wireless communications via at least the subset of the predicted set of cells based on the verifying.

In some examples, the information associated with the predicted movement trajectory includes a current serving cell associated with a current location of the UE, a current tracking area associated with the current location of the UE, a set of one or more cells corresponding to the predicted movement trajectory, a set of one or more tracking areas corresponding to the predicted movement trajectory, a destination associated with the predicted movement trajectory, an identity of the UE, or any combination thereof.

In some examples, the SI component 630 is capable of, configured to, or operable to support a means for receiving, via the SI, a set of multiple version identity values, each version identity value of the set of multiple version identity values associated with a respective cell of the predicted set of cells.

In some examples, the verification component 645 is capable of, configured to, or operable to support a means for detecting a first cell of the predicted set of cells. In some examples, the verification component 645 is capable of, configured to, or operable to support a means for detecting a current version identity value for the first cell, where the verifying is based on comparing the current version identity value for the first cell to a first version identity value of the set of multiple version identity values received via the SI.

In some examples, the verification component 645 is capable of, configured to, or operable to support a means for receiving second SI via the first cell, the second SI including an indication of the current version identity value.

In some examples, the feedback component 640 is capable of, configured to, or operable to support a means for transmitting feedback on an accuracy of the predicted set of cells based on a comparison between a set of detected cells and the predicted set of cells, a validity of the SI, or a combination thereof.

In some examples, the SI component 630 is capable of, configured to, or operable to support a means for receiving, via the SI, an expiry time associated with the SI for each cell of the predicted set of cells, where the predicted set of cells are considered valid until expiration of the expiry time.

In some examples, the predicted trajectory information message component 625 is capable of, configured to, or operable to support a means for transmitting, in the message, a request for the SI for a time interval, where the predicted set of cells are considered valid until expiration of the time interval.

In some examples, the verification component 645 is capable of, configured to, or operable to support a means for determining that the SI for at least one cell of at least the subset of the predicted set of cells is expired based on verifying the SI. In some examples, the SI component 630, the wireless communications component 635, or both are capable of, configured to, or operable to support a means for receiving updated SI for the at least one cell based on determining that the SI is expired.

In some examples, the verification component 645 is capable of, configured to, or operable to support a means for detecting at least one cell that is not included in the predicted set of cells. In some examples, the SI component 630, the wireless communications component 635, or both are capable of, configured to, or operable to support a means for receiving SI for the at least one cell.

In some examples, the predicted set of cells are associated with a portion of a predicted or historical trajectory of the UE.

In some examples, to support receiving the SI for the predicted set of cells, the SI component 630 is capable of, configured to, or operable to support a means for receiving the SI via UP or CP signaling.

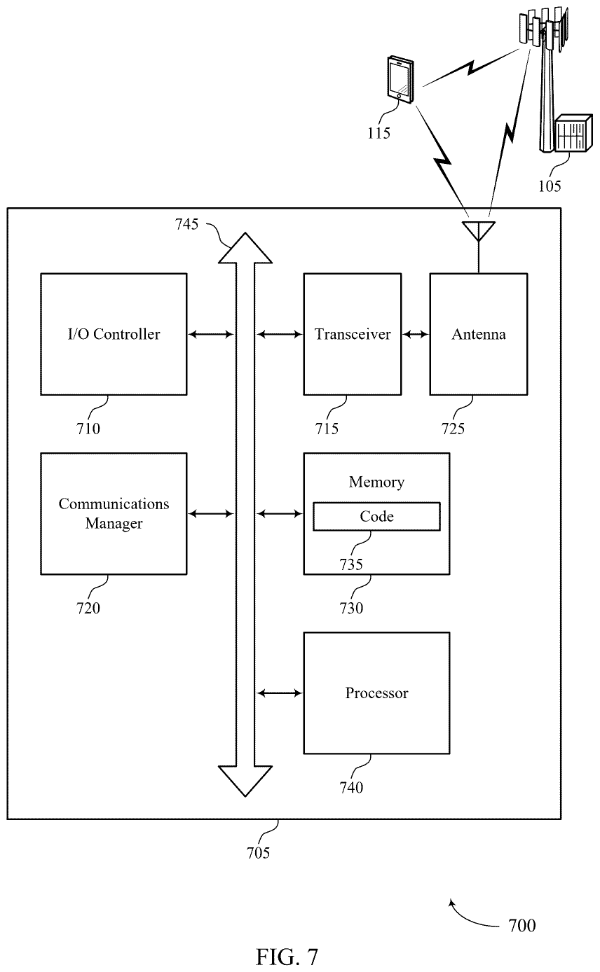

FIG. 7 shows a diagram of a system 700 including a device 705 that supports SI acquisition for energy saving in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more GPUs, one or more NPUs (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting SI acquisition for energy saving). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communication in accordance with examples as disclosed herein. For example, the communications manager 720 is capable of, configured to, or operable to support a means for transmitting a message including information associated with a predicted movement trajectory of the UE. The communications manager 720 is capable of, configured to, or operable to support a means for receiving SI for a predicted set of cells corresponding to the predicted movement trajectory of the UE. The communications manager 720 is capable of, configured to, or operable to support a means for verifying the SI received for at least a subset of the predicted set of cells. The communications manager 720 is capable of, configured to, or operable to support a means for performing wireless communications via at least the subset of the predicted set of cells based on the verifying.

By including or configuring the communications manager 720 in accordance with examples as described herein, the device 705 may support techniques reduced latency, improved user experience related to reduced processing, reduced power consumption, longer battery life, and improved utilization of processing capability.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of SI acquisition for energy saving as described herein, or the at least one processor 740 and the at least one memory 730 may be otherwise configured to, individually or collectively, perform or support such operations.

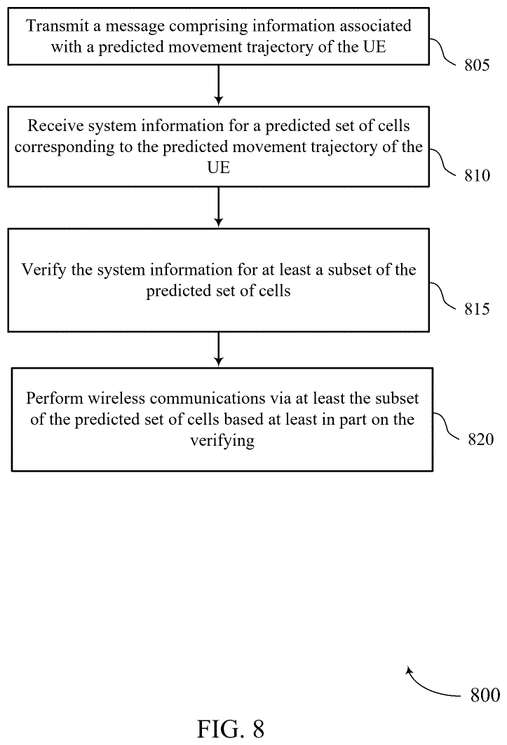

FIG. 8 shows a flowchart illustrating a method 800 that supports SI acquisition for energy saving in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include transmitting a message comprising information associated with a predicted movement trajectory of the UE. The operations of 805 may be performed in accordance with examples as disclosed herein. In some examples, aspects of the operations of 805 may be performed by a predicted trajectory information message component 625 as described with reference to FIG. 6.

At 810, the method may include receiving SI for a predicted set of cells corresponding to the predicted movement trajectory of the UE. The operations of 810 may be performed in accordance with examples as disclosed herein. In some examples, aspects of the operations of 810 may be performed by an SI component 630 as described with reference to FIG. 6.

At 815, the method may include verifying the SI received for at least a subset of the predicted set of cells. The operations of 815 may be performed in accordance with examples as disclosed herein. In some examples, aspects of the operations of 815 may be performed by a verification component 645 as described with reference to FIG. 6.

At 820, the method may include performing wireless communications via at least the subset of the predicted set of cells based at least in part on the verifying. The operations of 820 may be performed in accordance with examples as disclosed herein. In some examples, aspects of the operations of 820 may be performed by a wireless communications component 635 as described with reference to FIG. 6.

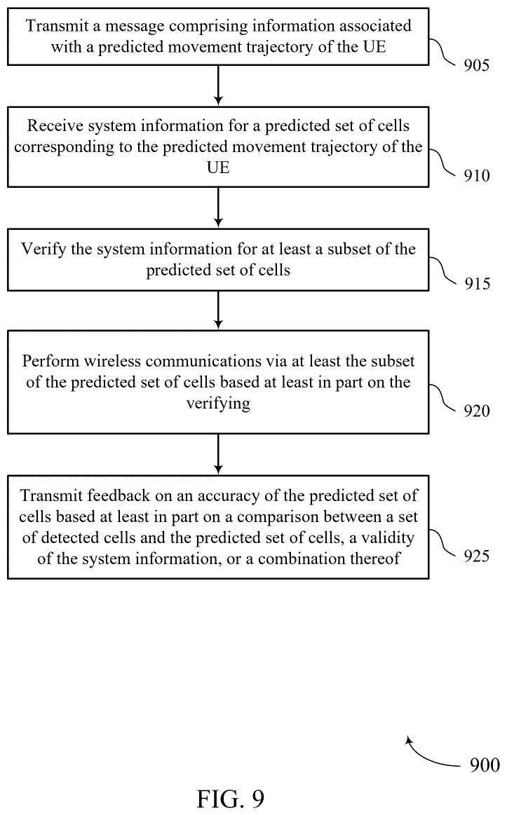

FIG. 9 shows a flowchart illustrating a method 900 that supports SI acquisition for energy saving in accordance with one or more aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include transmitting a message comprising information associated with a predicted movement trajectory of the UE. The operations of 905 may be performed in accordance with examples as disclosed herein. In some examples, aspects of the operations of 905 may be performed by a predicted trajectory information message component 625 as described with reference to FIG. 6.

At 910, the method may include receiving SI for a predicted set of cells corresponding to the predicted movement trajectory of the UE. The operations of 910 may be performed in accordance with examples as disclosed herein. In some examples, aspects of the operations of 910 may be performed by an SI component 630 as described with reference to FIG. 6.

At 915, the method may include verifying the SI received for at least a subset of the predicted set of cells. The operations of 915 may be performed in accordance with examples as disclosed herein. In some examples, aspects of the operations of 915 may be performed by a verification component 645 as described with reference to FIG. 6.

At 920, the method may include performing wireless communications via at least the subset of the predicted set of cells based at least in part on the verifying. The operations of 920 may be performed in accordance with examples as disclosed herein. In some examples, aspects of the operations of 920 may be performed by a wireless communications component 635 as described with reference to FIG. 6.

At 925, the method may include transmitting feedback on an accuracy of the predicted set of cells based at least in part on a comparison between a set of detected cells and the predicted set of cells, a validity of the SI, or a combination thereof. The operations of 925 may be performed in accordance with examples as disclosed herein. In some examples, aspects of the operations of 925 may be performed by a feedback component 640 as described with reference to FIG. 6.

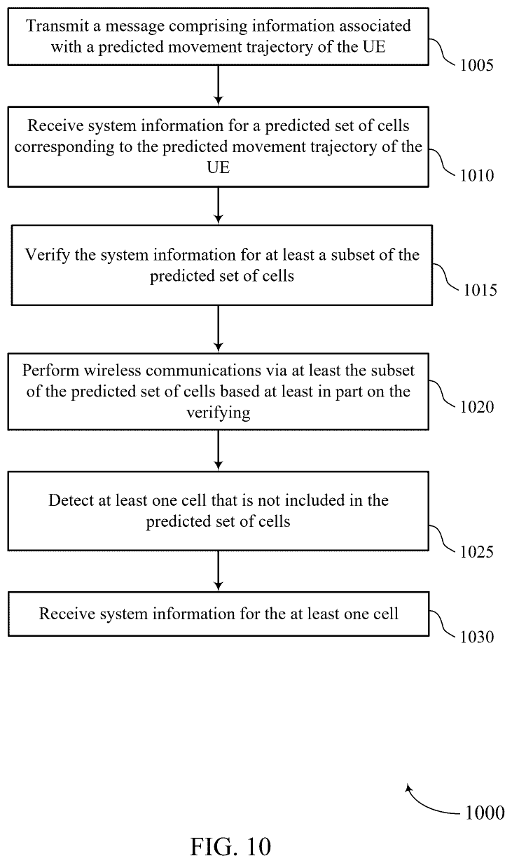

FIG. 10 shows a flowchart illustrating a method 1000 that supports SI acquisition for energy saving in accordance with one or more aspects of the present disclosure. The operations of the method 1000 may be implemented by a UE or its components as described herein. For example, the operations of the method 1000 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1005, the method may include transmitting a message comprising information associated with a predicted movement trajectory of the UE. The operations of 1005 may be performed in accordance with examples as disclosed herein. In some examples, aspects of the operations of 1005 may be performed by a predicted trajectory information message component 625 as described with reference to FIG. 6.

At 1010, the method may include receiving SI for a predicted set of cells corresponding to the predicted movement trajectory of the UE. The operations of 1010 may be performed in accordance with examples as disclosed herein. In some examples, aspects of the operations of 1010 may be performed by an SI component 630 as described with reference to FIG. 6.

At 1015, the method may include verifying the SI received for at least a subset of the predicted set of cells. The operations of 1015 may be performed in accordance with examples as disclosed herein. In some examples, aspects of the operations of 1015 may be performed by a verification component 645 as described with reference to FIG. 6.

At 1020, the method may include performing wireless communications via at least the subset of the predicted set of cells based at least in part on the verifying. The operations of 1020 may be performed in accordance with examples as disclosed herein. In some examples, aspects of the operations of 1020 may be performed by a wireless communications component 635 as described with reference to FIG. 6.

At 1025, the method may include detecting at least one cell that is not included in the predicted set of cells. The operations of 1025 may be performed in accordance with examples as disclosed herein. In some examples, aspects of the operations of 1025 may be performed by a verification component 645 as described with reference to FIG. 6.

At 1030, the method may include receiving system information for the at least one cell. The operations of 1030 may be performed in accordance with examples as disclosed herein. In some examples, aspects of the operations of 1030 may be performed by a wireless communications component 635 or an SI component 630 as described with reference to FIG. 6.

The following provides an overview of aspects of the present disclosure:

Aspect 1: A method for wireless communication by a UE, comprising: transmitting a message comprising information associated with a predicted movement trajectory of the UE; receiving SI for a predicted set of cells corresponding to the predicted movement trajectory of the UE; verifying the SI received for at least a subset of the predicted set of cells; and performing wireless communications via at least the subset of the predicted set of cells based at least in part on the verifying.

Aspect 2: The method of aspect 1, wherein the information associated with the predicted movement trajectory comprises a current serving cell associated with a current location of the UE, a current tracking area associated with the current location of the UE, a set of one or more cells corresponding to the predicted movement trajectory, a set of one or more tracking areas corresponding to the predicted movement trajectory, a destination associated with the predicted movement trajectory, an identity of the UE, or any combination thereof.

Aspect 3: The method of any of aspects 1 through 2, further comprising: receiving, via the SI, a plurality of version identity values, each version identity value of the plurality of version identity values associated with a respective cell of the predicted set of cells.

Aspect 4: The method of aspect 3, further comprising: detecting a first cell of the predicted set of cells; and detecting a current version identity value for the first cell, wherein the verifying is based at least in part on comparing the current version identity value for the first cell to a first version identity value of the plurality of version identity values received via the SI.

Aspect 5: The method of aspect 4, further comprising: receiving second SI via the first cell, the second SI comprising an indication of the current version identity value.

Aspect 6: The method of any of aspects 1 through 5, further comprising: transmitting feedback on an accuracy of the predicted set of cells based at least in part on a comparison between a set of detected cells and the predicted set of cells, a validity of the SI, or a combination thereof.

Aspect 7: The method of any of aspects 1 through 6, further comprising: receiving, via the SI, an expiry time associated with the SI for each cell of the predicted set of cells, wherein the predicted set of cells are considered valid until expiration of the expiry time.

Aspect 8: The method of any of aspects 1 through 7, further comprising: transmitting, in the message, a request for the SI for a time interval, wherein the predicted set of cells are considered valid until expiration of the time interval.

Aspect 9: The method of any of aspects 1 through 8, further comprising: determining that the SI for at least one cell of at least the subset of the predicted set of cells is expired based at least in part on the verifying; and receiving updated SI for the at least one cell based at least in part on determining that the SI is expired.

Aspect 10: The method of any of aspects 1 through 9, further comprising: detecting at least one cell that is not included in the predicted set of cells; and receiving SI for the at least one cell.

Aspect 11: The method of any of aspects 1 through 10, wherein the predicted set of cells are associated with a portion of a predicted or historical trajectory of the UE.

Aspect 12: The method of any of aspects 1 through 11, wherein receiving the SI for the predicted set of cells further comprises: receiving the SI via UP or CP signaling.

Aspect 13: A UE for wireless communication, comprising one or more memories storing processor-executable code, and one or more processors coupled with (e.g., operatively, communicatively, functionally, electronically, or electrically) the one or more memories and individually or collectively operable to execute the code (e.g., directly, indirectly, after pre-processing, without pre-processing) to cause the UE to perform a method of any of aspects 1 through 12.

Aspect 14: A non-transitory computer-readable medium storing code for wireless communication at a UE, the code comprising instructions executable by one or more processors processor (e.g., directly, indirectly, after pre-processing, without pre-processing) to perform a method of any of aspects 1 through 12.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software (e.g., executed by a processor), or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, software, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit a message comprising information associated with a predicted movement trajectory of the UE;
receive system information for a predicted set of cells corresponding to the predicted movement trajectory of the UE;
verify the system information received for at least a subset of the predicted set of cells; and
perform wireless communications via at least the subset of the predicted set of cells based at least in part on the verifying.

2. The UE of claim 1, wherein the information associated with the predicted movement trajectory comprises a current serving cell associated with a current location of the UE, a current tracking area associated with the current location of the UE, a set of one or more cells corresponding to the predicted movement trajectory, a set of one or more tracking areas corresponding to the predicted movement trajectory, a destination associated with the predicted movement trajectory, an identity of the UE, or any combination thereof.

3. The UE of claim 1, wherein the one or more processors are individually or collectively further operable to execute the code to cause the UE to:
receive, via the system information, a plurality of version identity values, each version identity value of the plurality of version identity values associated with a respective cell of the predicted set of cells.

4. The UE of claim 3, wherein the one or more processors are individually or collectively further operable to execute the code to cause the UE to:
detect a first cell of the predicted set of cells; and
detect a current version identity value for the first cell, wherein the verifying is based at least in part on comparing the current version identity value for the first cell to a first version identity value of the plurality of version identity values received via the system information.

5. The UE of claim 4, wherein the one or more processors are individually or collectively further operable to execute the code to cause the UE to:
receive second system information via the first cell, the second system information comprising an indication of the current version identity value.

6. The UE of claim 1, wherein the one or more processors are individually or collectively further operable to execute the code to cause the UE to:
transmit feedback on an accuracy of the predicted set of cells based at least in part on a comparison between a set of detected cells and the predicted set of cells, a validity of the system information, or a combination thereof.

7. The UE of claim 1, wherein the one or more processors are individually or collectively further operable to execute the code to cause the UE to:
receive, via the system information, an expiry time associated with the system information for each cell of the predicted set of cells, wherein the predicted set of cells are considered valid until expiration of the expiry time.

8. The UE of claim 1, wherein the one or more processors are individually or collectively further operable to execute the code to cause the UE to:
transmit, in the message, a request for the system information for a time interval, wherein the predicted set of cells are considered valid until expiration of the time interval.

9. The UE of claim 1, wherein the one or more processors are individually or collectively further operable to execute the code to cause the UE to:
determine that the system information for at least one cell of at least the subset of the predicted set of cells is expired based at least in part on the verifying; and
receive updated system information for the at least one cell based at least in part on determining that the system information is expired.

10. The UE of claim 1, wherein the one or more processors are individually or collectively further operable to execute the code to cause the UE to:
detect at least one cell that is not included in the predicted set of cells; and
receive system information for the at least one cell.

11. The UE of claim 1, wherein the predicted set of cells are associated with a portion of a predicted or historical trajectory of the UE.

12. The UE of claim 1, wherein, to receive the system information for the predicted set of cells, the one or more processors are individually or collectively further operable to execute the code to cause the UE to:
receive the system information via user plane or control plane signaling.

13. A method for wireless communication by a user equipment (UE), comprising:
transmitting a message comprising information associated with a predicted movement trajectory of the UE;
receiving system information for a predicted set of cells corresponding to the predicted movement trajectory of the UE;
verifying the system information received for at least a subset of the predicted set of cells; and
performing wireless communications via at least the subset of the predicted set of cells based at least in part on the verifying.

14. The method of claim 13, wherein the information associated with the predicted movement trajectory comprises a current serving cell associated with a current location of the UE, a current tracking area associated with the current location of the UE, a set of one or more cells corresponding to the predicted movement trajectory, a set of one or more tracking areas corresponding to the predicted movement trajectory, a destination associated with the predicted movement trajectory, an identity of the UE, or any combination thereof.

15. The method of claim 13, further comprising:
receiving, via the system information, a plurality of version identity values, each version identity value of the plurality of version identity values associated with a respective cell of the predicted set of cells.

16. The method of claim 15, further comprising:
detecting a first cell of the predicted set of cells; and
detecting a current version identity value for the first cell, wherein the verifying is based at least in part on comparing the current version identity value for the first cell to a first version identity value of the plurality of version identity values received via the system information.

17. The method of claim 16, further comprising:
receiving second system information via the first cell, the second system information comprising an indication of the current version identity value.

18. The method of claim 13, further comprising:
transmitting feedback on an accuracy of the predicted set of cells based at least in part on a comparison between a set of detected cells and the predicted set of cells, a validity of the system information, or a combination thereof.

19. The method of claim 13, further comprising:
receiving, via the system information, an expiry time associated with the system information for each cell of the predicted set of cells, wherein the predicted set of cells are considered valid until expiration of the expiry time.

20. A non-transitory computer-readable medium storing code for wireless communication, the code comprising instructions executable by at least one processor to:
transmit a message comprising information associated with a predicted movement trajectory of a user equipment (UE);
receive system information for a predicted set of cells corresponding to the predicted movement trajectory of the UE;
verify the system information for at least a subset of the predicted set of cells; and
perform wireless communications via at least the subset of the predicted set of cells based at least in part on the verifying.
